(19) United States
(12) Patent Application Publication
(10) Pub. No.: US 2026/0031346 A1
(43) Pub. Date: Jan. 29, 2026

(54) CATHODE MATERIAL CONTAINING HALOGEN-OXYGEN COMPOUND, METHOD FOR PREPARING SAME, AND CATHODE PLATE

(71) Applicant: Eastern Institute for Advanced Study, Ningbo (CN)

(72) Inventors: Xiaona LI, Ningbo (CN); Xueliang SUN, Ningbo (CN); Han WU, Ningbo (CN); Simeng ZHANG, Ningbo (CN); Junyi YUE, Ningbo (CN)

(73) Assignee: Eastern Institute for Advanced Study, Ningbo (CN)

(21) Appl. No.: 19/283,171

(22) Filed: Jul. 28, 2025

(30) Foreign Application Priority Data
Jul. 29, 2024 (CN) 2024110176013
Jul. 29, 2024 (CN) 2024110178305

(51) Int. Cl. H01M 4/525; H01M 4/505; H01M 4/58

(52) U.S. Cl. CPC H01M 4/525; H01M 4/505; H01M 4/5825

(57) ABSTRACT

The present disclosure discloses a cathode material containing a halogen-oxygen compound, a method for preparing the same, and a cathode plate. The method includes the steps: ball milling at least one crystalline phase cathode material and at least one halide, and converting the halide into the halogen-oxygen compound through corrosion and a solid solution reaction during a ball milling process, so as to obtain the cathode material containing the halogen-oxygen compound. The cathode material provided by the present disclosure has a high ionic conduction rate and a low coefficient of expansion, as well as high capacity and good cycling performance.

### CROSS-REFERENCE TO RELATED APPLICATIONS

The application claims priority to Chinese patent application No. 2024110178305, filed on Jul. 29, 2024 and Chinese patent application No. 2024110176013, filed on Jul. 29, 2024, the entire contents of which are incorporated herein by reference.

### TECHNICAL FIELD

The present disclosure relates to the technical field of battery materials, in particular to a cathode material containing a halogen-oxygen compound, a method for preparing the same, and application.

### BACKGROUND

Alkali metal ion batteries and supercapacitors are regarded as ideal energy storage devices in next-generation energy storage systems. These energy storage devices are an indispensable part of future green energy. Therefore, there is an urgent need to develop high-performance, low-cost, and environmentally friendly electrode materials to meet the requirements for high energy density and long cycle life. So far, people have conducted in-depth research on various crystalline electrodes, including carbon-based crystalline electrodes, alloy-based crystalline electrodes, and organic-based crystalline electrodes. Strategies to improve the electrochemical performance of these electrodes are summarized as follows: (1) unique structural design to balance morphology and surface area; (2) reduction of the size of an active material; (3) doping of heteroatoms/introduction of vacancies; (4) self-supporting substrates; and (5) construction of heterostructures. Although the electrochemical performance of various energy storage systems have been greatly improved by these methods, it is often difficult to satisfy both the capacity performance and the cycling performance of cathode materials in the current study. For example, lithium iron phosphate has high safety and long cycle life, but relatively low energy density; lithium cobaltate has high energy density but short cycle life; ternary materials have good overall performance, but the material price is high; and lithium manganate is a low-cost material, but with low energy density.

Therefore, finding cathode materials for alkali metal ion batteries that satisfy both high capacity and good cycling performance has become the main goal of various researchers. Modification of cathode materials is the main method to improve the battery performance of the cathode materials. Surface coating is a commonly used modification method, but at present, most coating materials are lithium/sodium “insulators”, which hinder the migration and diffusion of lithium/sodium ions. At high magnifications, the lithium/sodium ion transport rate and stability of the materials are poor, resulting in poor rate performance. Therefore, how to design cathode materials for alkali metal ion batteries with high specific capacity, long cycle life and high safety has become one of the urgent problems to be solved in the industry.

### SUMMARY

A technical problem to be solved by the present disclosure is: to provide a new cathode material and a method for preparing the same. The present disclosure provides a cathode material containing a halogen-oxygen compound, a method for preparing the same, and application in order to solve the above problem. In the present disclosure, by using a one-step ball milling method and discarding complicated and cumbersome synthesis steps, the production cost is effectively reduced; moreover, the method is highly universal, and a novel cathode material that has both excellent cycling stability and high capacity is finally developed, which lays a foundation for large-scale production of next-generation cathode materials containing halogen-oxygen compounds.

The present disclosure is implemented through the following technical solutions:

The present disclosure provides a method for preparing a cathode material containing a halogen-oxygen compound. The method includes:
ball milling at least one crystalline phase cathode material and at least one halide MX_{y}, and converting the halide into the halogen-oxygen compound through corrosion and a solid solution reaction during a ball milling process, so as to obtain the cathode material containing the halogen-oxygen compound, wherein
in the halide MX_{y}, M includes at least one of metallic elements or semi-metallic elements other than radioactive metallic elements, X includes at least one of F, Cl, Br or I, and y is an integer between 1 and 6;
in a case where one type of crystalline phase cathode material is provided, the crystalline phase cathode material is a lithium-ion battery cathode material or a sodium-ion battery cathode material; in a case where two or more types of crystalline phase cathode materials are provided, the crystalline phase cathode materials are lithium-ion battery cathode materials; and the lithium-ion battery cathode material and the sodium-ion battery cathode material are both oxygen-containing materials.

In the method for preparing the cathode material provided by the present disclosure, corrosion and the solid solution reaction mean that the halide and the crystalline phase cathode material may undergo a chemical reaction during the ball milling process, and the halide can be converted into the halogen-oxygen compound through the reaction, so that the cathode material containing the halogen-oxygen compound is obtained. The cathode material containing the halogen-oxygen compound prepared by the above method for preparing of the present disclosure has defects and vacancies, and can be used as a lithium/sodium storage cathode material. The halogen-oxygen compound in the cathode material may alleviate a mechanical strain caused by intercalation and de-intercalation of ions, and a volume change during a cycling process is mitigated, and is reduced by greater than 30%, so that the cycling stability of a structure during a de-intercalation process of lithium or sodium is ensured. The halogen-oxygen compound can delay a decomposition process of the cathode material, while the release of oxygen in the cathode material may be slowed down by oxidative decomposition of the halogen-oxygen compound. The halogen-oxygen compound can also promote a phase change of oxidized chlorides to oxides to capture oxygen species, so that the release of a combustible oxygen gas is inhibited, and the thermal stability of the cathode material is improved. At the same time, the cathode material containing the halogen-oxygen compound of the present disclosure has a high ionic conduction rate, can realize both a high ionic conduction rate of >10⁻⁷ S/cm and a high electronic conduction rate of >10⁻⁴ S/cm, can even realize a high ionic conduction rate of >10⁻⁵ S/cm and a high electronic conduction rate of >10⁻² S/cm, and has excellent electrochemical performance.

Optionally, the lithium-ion battery cathode material includes at least one of a layered-type material, a spinel-type material or an olivine-type material.

Further optionally, the layered-type material includes at least one of LiₓCoO₂, LiₓNiO₂, LiₓMnO₂, LiₓNi_{1-y}Mn_{y}O₂, LiₓNi_{1-y}Co_{y}O₂, LiₓNi_{z}Co_{y}Mn_{1-x-y}O₂, LiₓCo_{1-y}Mn_{y}O₂ or Li₂MnO₃, where 0.5<x<1.10; in LiₓNi_{1-y}Mn_{y}O₂, 0.1≤y≤0.5; in LiₓNi_{1-y}Co_{y}O₂, 0.1≤y≤0.5; in LiₓNi_{z}Co_{y}Mn_{1-x-y}O₂, 0.1≤z≤0.8, 0.1≤y≤0.8, and 0.2≤z+y≤0.9; and in LiₓCo_{1-y}Mn_{y}O₂, 0.1≤y≤0.5.

LiₓCoO₂ is preferably LiCoO₂, LiₓNiO₂ is preferably LiNiO₂, LixMnO₂ is preferably LiMnO₂, LiₓNi_{1-y}Co_{y}O₂ is preferably LiNi_{1-y}Co_{y}O₂, and LiₓNi_{z}Co_{y}Mn_{1-z-y}O₂ is preferably LiNi_{0.8}Co_{0.1}Mn_{0.1}O₂.

Further optionally, the spinel-type material includes at least one of LiMn₂O₄ or LiNi_{0.5}Mn_{1.5}O₄.

Further optionally, the olivine-type material is LiNPO₄, where N is selected from at least one of Fe, Co, Mn or Ni. For example, the olivine-type material may be LiFePO₄, LiCoPO₄, and lithium ferromanganese phosphate (LiFe_{0.6}Mn_{0.4}PO₄).

Optionally, the sodium-ion battery cathode material includes at least one of a transition metal oxide material, a poly-anionic compound material or a Prussian blue compound material.

Further optionally, the transition metal oxide material includes Na_{0.5}Mn_{0.75}Ni_{0.25}O₂, Na_{7/9}Cu_{2/9}Fe_{1/9}Mn_{2/3}O₂, NaNi_{0.5}Mn_{0.5}O₂, Na_{2/3}Mn_{0.8}Fe_{0.1}Ti_{0.1}O₂, Na_{2/3}Mn_{0.8}Fe_{0.2}O₂, Na_{0.5}Fe_{0.5}Mn_{0.5}O₂ or Na_{2/3}Mn_{0.8}Ni_{0.1}Ti_{0.05}Fe_{0.05}O₂.

Further optionally, the poly-anionic compound material includes at least one of sodium vanadium phosphate or sodium iron phosphate.

Optionally, one type of crystalline phase cathode material is provided. In a case where one type of crystalline phase cathode material is used, upon ball milling of the same with the halide, the obtained cathode material containing the halogen-oxygen compound is of a core-shell structure, including a core and a shell coating the core. The core is the crystalline phase cathode material, and the shell is an amorphous halogen-oxygen compound. From the core to the shell, a halogen component increases in a gradient mode, and a metallic element component decreases in a gradient mode. The metallic element is a metallic element in the crystalline phase cathode material. Unlike traditional amorphous cathode materials that have a disadvantage of not being able to deeply de-intercalate lithium or sodium, the amorphous halogen-oxygen compound obtained by the present disclosure can alleviate the mechanical strain caused by intercalation and de-intercalation of ions, and is less affected by shape rearrangement and volume changes, and the stability of the structure in the de-intercalation process of lithium or sodium can be ensured. For example, in the present disclosure, the halide aluminum chloride is taken as a dissociative agent, and upon ball milling, corrosion and the solid solution reaction with lithium cobaltate, a large number of defective sites and Al—O—Cl amorphous structures are generated on a surface of lithium cobaltate, which provides a large number of channels for rapidly transporting lithium ions, significantly enhances the cycling capacity of the cathode material, and can achieve an increase of 500 or more times of the ionic conduction rate compared with that of a corresponding crystalline phase cathode material at a room temperature. The existence of this type of amorphous structures can also be proved by corresponding XRD and TEM data subsequently. At the same time, most of amorphous material synthesis processes are complicated and expensive in practical application. Different from traditional processes such as a solid phase method, a solution gel method and a combustion method, the present disclosure adopts a simple one-step ball milling synthesis method to realize rapid and large-scale preparation, which lays a persistent foundation for commercial application thereof.

Further optionally, one type of halide is provided, one type of crystalline phase cathode material is provided, and a mass ratio of the halide to the crystalline phase cathode material is 1:1 to 1:19.

Considering the control of the actual production cost, a proportion of the crystalline phase cathode material in total mass of the crystalline phase cathode material and the halide is not less than 50%. If a proportion of the additive amount of the crystalline phase cathode material is too low and a proportion of the additive amount of the halide is too high, the halide content in the finally formed cathode material may be too high, and sufficient specific capacity cannot be provided.

Based on experimental test results, in order to ensure the actual battery application effect after dissociation of the halide material, the proportion of the halide in the total mass of the crystalline phase cathode material and the halide is not less than 5%. Of course, the proportion of the additive amount of the halide also cannot be too low, otherwise the crystalline phase cathode material and the halide cannot effectively form the halogen-oxygen compound, resulting in insignificant improvement of the performance of the cathode material.

Further optionally, two types of halides are provided, one type of crystalline phase cathode material is provided, and a mass ratio of the two halides to the crystalline phase cathode material is 1:1:18 to 1:1:2.

Considering the control of the actual production cost, the proportion of the crystalline phase cathode material in the total mass of the crystalline phase cathode material and the halide is not less than 50%.

Based on the experimental test results, in order to ensure the actual battery application effect after dissociation of the halide material, a proportion of each type of halide in the total mass of the crystalline phase cathode material and the two types of halides is not less than 5%.

Optionally, at least two types, such as two or three types, of crystalline phase cathode materials are included. In a case where a plurality of crystalline phase cathode materials are used at the same time, solid solution treatment of the different crystalline phase cathode materials may be realized to form a solid solution type cathode material. Through the solid solution treatment of the different crystalline phase cathode materials, the cycling performance of the cathode material can be improved. For example, lithium cobaltate and lithium iron phosphate are subject to ball milling solid solution treatment, where a lithium iron phosphate layer is used both as an active material and a resistive barrier layer for overcharging and thermal runaway protection, so the solid solution type cathode material is not only resistant to an overcharging current, but also can significantly reduce the surface temperature in a case of overcharging, thereby significantly improving the cycling stability of lithium cobaltate. For another example, although lithium iron phosphate has the advantages of high specific capacity, high safety, low cost, etc., the discharge platform voltage is not high. By carrying out ball milling solid solution treatment on lithium iron phosphate and lithium manganate, gaps of micron-sized lithium manganate particles can be filled with submicron-sized fine lithium iron phosphate particles, so that direct contact between an electrolyte and lithium manganate is effectively blocked, the dissolution of manganese is inhibited, electron transfer between the particles is improved, the internal resistance of a battery is reduced, and the average operating voltage of the battery is increased.

In a case where an addition ratio of the halide is too high, most of the capacity of the solid solution type cathode material comes from the halide, which results in an obvious shortage of battery capacity and non-ideal electrochemical performance. In a case where the addition ratio of the halide is too low, the difficulty of solid solution between different crystalline phase cathode materials increases significantly, the synergistic effect between the different crystalline phase cathode materials cannot be fully played, and the cycling stability decreases. Therefore, the ratio of the halide to the crystalline phase cathode material needs to be controlled.

Further optionally, one type of halide is provided, two types of crystalline phase cathode materials are provided, and a mass ratio of the halide to the two types of crystalline phase cathode materials is 2:1:1 to 2:19:19.

Further optionally, one type of halide is provided, three types of crystalline phase cathode materials are provided, and a mass ratio of the halide to the three types of crystalline phase cathode materials is 3:1:1:1 to 1:33:33:33.

More preferably, one type of halide is provided, three types of crystalline phase cathode materials are provided, and a mass ratio of the halide to the three types of crystalline phase cathode materials is 1:3:3:3 to 3:4:4:4.

Further optionally, two types of halides are provided, two types of crystalline phase cathode materials are provided, and a mass ratio of the two types of halides to the two types of crystalline phase cathode materials is 1:1:1:1 to 1:1:99:99.

More preferably, two types of halides are provided, two types of crystalline phase cathode materials are provided, and a mass ratio of the two types of halides to the two types of crystalline phase cathode materials is 1:1:9:9 to 1:1:4:4.

Further optionally, two types of halides are provided, three types of crystalline phase cathode materials are provided, and a mass ratio of the two types of halides to the three types of crystalline phase cathode materials is 3:3:2:2:2 to 1:1:66:66:66.

More preferably, two types of halides are provided, three types of crystalline phase cathode materials are provided, and a mass ratio of the two types of halides to the three types of crystalline phase cathode materials is 1:1:6:6:6 to 3:3:8:8:8.

Optionally, M in the halide MX_{y} includes a metallic element other than radioactive metallic elements (e.g., polonium, radon, francium, radium, actinium, thorium, protactinium, uranium, neptunium, plutonium), including, but not limited to, lithium, sodium, potassium, magnesium, calcium, aluminum, lanthanum, tantalum, hafnium, zirconium and the like.

Further optionally, M in the halide MX_{y} includes at least one of aluminum, lanthanum, tantalum, hafnium or zirconium.

Optionally, the halide includes at least one of aluminum fluoride, aluminum chloride, aluminum bromide, aluminum iodide, lanthanum fluoride, lanthanum chloride, lanthanum bromide, lanthanum iodide, tantalum fluoride, tantalum chloride, tantalum bromide, tantalum iodide, hafnium fluoride, hafnium chloride, hafnium bromide, hafnium iodide, zirconium fluoride, zirconium chloride, zirconium bromide or zirconium iodide.

Further optionally, the halide is a combination of two types of halides, and the two types of halides are a combination of aluminum chloride and any one of the following halides: lanthanum chloride, tantalum chloride, hafnium chloride, zirconium chloride, lanthanum fluoride, lanthanum bromide, lanthanum iodide, tantalum fluoride, tantalum bromide, tantalum iodide, hafnium fluoride, hafnium bromide, hafnium iodide, zirconium fluoride, zirconium bromide, and zirconium iodide.

Furthermore, the halides may be a combination of aluminum chloride and lanthanum chloride, a combination of aluminum chloride and lanthanum fluoride, a combination of aluminum chloride and lanthanum bromide, a combination of aluminum chloride and lanthanum iodide, a combination of aluminum chloride and tantalum chloride, a combination of aluminum chloride and tantalum fluoride, a combination of aluminum chloride and tantalum bromide, a combination of aluminum chloride and tantalum iodide, a combination of aluminum chloride and hafnium chloride, a combination of aluminum chloride and hafnium fluoride, a combination of aluminum chloride and hafnium bromide, a combination of aluminum chloride and hafnium bromide, a combination of aluminum chloride and zirconium chloride, a combination of aluminum chloride and zirconium fluoride, a combination of aluminum chloride and zirconium bromide, or a combination of aluminum chloride and zirconium iodide.

Optionally, one type of crystalline phase cathode material is provided, a ball milling speed is 100 rpm to 700 rpm, and a ball milling duration is 0.1 h to 48 h.

Optionally, at least two types of crystalline phase cathode materials are included, the ball milling speed is 100 rpm to 700 rpm, and the ball milling duration is 0.1 h to 22 h. More preferably, the ball milling speed is 300 rpm to 600 rpm, and the ball milling duration is 0.1 h to 6 h.

The present disclosure provides a cathode material containing a halogen-oxygen compound prepared by the method for preparing described above.

In a case where one type of crystalline phase cathode material is used, the prepared cathode material containing the halogen-oxygen compound includes a core and a shell coating the core. The core is a crystalline phase cathode material, and the shell is an amorphous halogen-oxygen compound. From the core to the shell, the halogen content increases in a gradient mode, and the metallic element content decreases in a gradient mode. The “metallic element” here refers to a metallic element in the crystalline phase cathode material.

In a case where two or more types of crystalline phase cathode materials are used, the prepared cathode material containing the halogen-oxygen compound is a solid solution type cathode material.

The present disclosure provides a cathode plate. The cathode plate includes the cathode material containing the halogen-oxygen compound described above, or the cathode material prepared by the method for preparing described above.

The present disclosure provides a battery. The battery includes the cathode plate described above.

Compared with the prior art, the present disclosure has the following beneficial effects:
in the method for preparing the cathode material containing the halogen-oxygen compound of the present disclosure, the halide and the crystalline phase cathode material are directly subject to ball milling by a simple ball milling method, the operation steps are simple, no complicated synthesis condition is needed, so that the production efficiency is significantly improved, and the preparation cost is saved. In the method for preparing of the present disclosure, the halide and the crystalline phase cathode material undergo a chemical reaction during the ball milling process, and the halide can be converted into the halogen-oxygen compound through the reaction, so that the cathode material containing the halogen-oxygen compound is obtained.

The cathode material containing the halogen-oxygen compound prepared by the present disclosure has defects and vacancies, and can be used as a lithium/sodium storage cathode material. The halogen-oxygen compound in the cathode material can alleviate the mechanical strain caused by intercalation and de-intercalation of ions, and the volume change during a cycling process is mitigated, so that the cycling stability of the structure during the de-intercalation process of lithium or sodium is improved. The halogen-oxygen compound can delay the decomposition process of the cathode material, while the release of oxygen in the cathode material is slowed down by oxidative decomposition of the halogen-oxygen compound. The halogen-oxygen compound can also promote the phase change of oxidized chlorides to oxides to capture oxygen species, so that the release of a combustible oxygen gas is inhibited, and the thermal stability of the cathode material is improved. At the same time, the cathode material containing the halogen-oxygen compound of the present disclosure has multiple alkali metal ion storage sites and diffusion channels, so as to have a high ionic conduction rate and excellent electrochemical performance. Therefore, the cathode material containing the halogen-oxygen compound prepared by the present disclosure has both good capacity performance and cycling performance.

### BRIEF DESCRIPTION OF DRAWINGS

FIG. 1 is a TEM lattice diagram of a cathode material containing a halogen-oxygen compound provided in Example 1.

FIG. 2 is a TEM morphology diagram of a cathode material containing a halogen-oxygen compound prepared in Example 1.

FIG. 3 is an SEM morphology diagram of a cathode material prepared in Comparative Example 1.

FIG. 4 is an SEM morphology diagram of a cathode material prepared in Comparative Example 2.

FIG. 5 is an XRD diagram of a cathode material containing a halogen-oxygen compound prepared in Example 1.

FIG. 6 is a charge-discharge curve of a cathode material containing a halogen-oxygen compound prepared in Example 1 at a current density of 0.5 A g⁻¹.

FIG. 7 shows cycle curves of a cathode material containing a halogen-oxygen compound prepared in Example 1 at a current density of 0.5 A g⁻¹, where the curve composed of squares represents Coulomb efficiency, and the curve composed of circles represents capacity.

FIG. 8 shows cycle curves of a cathode material prepared in Comparative Example 1 at a current density of 0.5 A g⁻¹, where the curve composed of squares represents Coulomb efficiency, and the curve composed of circles represents capacity.

FIG. 9 shows cycle curves of a cathode material prepared in Comparative Example 2 at a current density of 0.5 A g⁻¹, where the curve composed of squares represents Coulomb efficiency, and the curve composed of circles represents capacity.

FIG. 10 is an SEM lattice diagram of a cathode material containing a halogen-oxygen compound prepared in Example 15.

FIG. 11 is an SEM morphology diagram of a cathode material prepared in Comparative Example 5.

FIG. 12 is an SEM morphology diagram of a cathode material prepared in Comparative Example 6.

FIG. 13 is an SEM morphology diagram of a cathode material prepared in Comparative Example 7.

FIG. 14 is an SEM morphology diagram of a cathode material prepared in Comparative Example 8.

FIG. 15 shows cycle curves of a cathode material containing a halogen-oxygen compound prepared in Example 15 at a current density of 0.3 A g⁻¹, where the curve composed of squares represents Coulomb efficiency, and the curve composed of circles represents capacity.

FIG. 16 shows cycle curves of a cathode material prepared in Comparative Example 3 at a current density of 0.3 A g⁻¹, where the curve composed of squares represents Coulomb efficiency, and the curve composed of circles represents capacity.

FIG. 17 shows cycle curves of a cathode material prepared in Comparative Example 4 at a current density of 0.3 A g⁻¹, where the curve composed of squares represents Coulomb efficiency, and the curve composed of circles represents capacity.

### DETAILED DESCRIPTION OF THE EMBODIMENTS

In order to make the objects, technical solutions and advantages of the present disclosure clearer and more understandable, the present disclosure is further described in detail below in conjunction with examples and accompanying drawings. The schematic embodiments of the present disclosure and the descriptions thereof are used merely for the purpose of explaining the present disclosure, and are not to be taken as a limitation of the present disclosure.

### Example 1

This example provided a cathode material containing a halogen-oxygen compound. A specific method for preparing was as follows:
Step 1: 0.4 g aluminum chloride and 1.6 g lithium cobaltate (LiCoO₂) solid powders were added to a high-energy ball milling jar of 500 mL,
where a mass ratio of aluminum chloride to lithium cobaltate was 1:4.

Step 2: upon every 10 min of ball milling, ball milling was suspended for 5 min and then continued; and then the above steps were repeated, where a total ball milling duration was controlled as 0.5 h, and a ball milling speed was maintained at 500 rpm.

Except for the ball milling process, loading and unloading processes were carried out in a vacuum glove box, and contents of oxygen and water were both controlled to be less than 0.1 ppm.

### Comparative Example 1

This comparative example differed from Example 1 only in that: 10 g aluminum chloride and 1 g lithium cobaltate (LiCoO₂) solid powders were added to a high-energy ball milling jar of 500 mL, where a mass ratio of aluminum chloride to lithium cobaltate was 10:1.

### Comparative Example 2

This comparative example differed from Example 1 only in that: 0.1 g aluminum chloride and 3.0 g lithium cobaltate (LiCoO₂) solid powders were added to a high-energy ball milling jar of 500 mL, where a mass ratio of aluminum chloride to lithium cobaltate was 1:30.

### Example 2

This example differed from Example 1 only in that: aluminum chloride was replaced with tantalum chloride.

### Example 3

This example differed from Example 1 only in that: aluminum chloride was replaced with zirconium chloride.

### Example 4

This example differed from Example 1 only in that: lithium cobaltate was replaced with lithium manganate (Li₂MnO₃).

### Example 5

This example differed from Example 1 only in that: aluminum chloride was replaced with zirconium chloride, and lithium cobaltate was replaced with lithium iron phosphate (LiFePO₄).

### Example 6

This example differed from Example 1 only in that: lithium cobaltate was replaced with sodium vanadium phosphate.

### Example 7

This example differed from Example 1 only in that: lithium cobaltate was replaced with sodium iron phosphate.

### Example 8

This example provided a cathode material containing a halogen-oxygen compound. A specific method for preparing was as follows:

Step 1: 0.2 g aluminum chloride, 0.2 g lanthanum chloride, and 1.6 g lithium cobaltate (LiCoO₂) solid powders were added to a high-energy ball milling jar of 500 mL,
where a mass ratio of aluminum chloride to lanthanum chloride to lithium cobaltate was 1:1:8.

Step 2: upon every 10 min of ball milling, ball milling was suspended for 5 min and then continued; and then the above steps were repeated, where a total ball milling duration was controlled as 0.5 h, and a ball milling speed was maintained at 500 rpm.

Except for the ball milling process, loading and unloading processes were carried out in a vacuum glove box, and contents of oxygen and water were both controlled to be less than 0.1 ppm.

### Example 9

This example differed from Example 8 only in that: 0.1 g aluminum chloride, 0.1 g lanthanum chloride and 1.8 g lithium cobaltate (LiCoO₂) solid powders were added to a high-energy ball milling jar of 500 mL, where a mass ratio of aluminum chloride to lanthanum chloride to lithium cobaltate was 1:1:18.

### Example 10

This example differed from Example 8 only in that: lanthanum chloride was replaced with zirconium chloride.

### Example 11

This example differed from Example 8 only in that: lanthanum chloride was replaced with hafnium chloride.

### Example 12

This example provided a cathode material containing a halogen-oxygen compound. A specific method for preparing was as follows:

Step 1: 0.2 g aluminum chloride, 0.2 g tantalum chloride, and 1.6 g NCM811 (LiN_{0.8}Co_{0.1}Mn_{0.1}O₂) solid powders were added to a high-energy ball milling jar of 500 mL,
where a mass ratio of aluminum chloride to tantalum chloride to NCM811 (LiN_{0.8}Co_{0.1}Mn_{0.1}O₂) was 1:1: 8.

Step 2: ball milling was carried out for 10 minutes, where a ball milling speed was maintained at 500 rpm.

Except for the ball milling process, loading and unloading processes were both carried out in a vacuum glove box, and contents of oxygen and water were both controlled to be less than 0.1 ppm.

### Example 13

This example differed from Example 8 only in that: 0.1 g aluminum chloride, 0.1 g lanthanum chloride, and 1.8 g lithium iron phosphate (LiFePO₄) solid powders were added to a high-energy ball milling jar of 500 mL, where a mass ratio of aluminum chloride to lanthanum chloride to lithium iron phosphate (LiFePO₄) was 1:1:18.

### Example 14

This example differed from Example 8 only in that: 0.1 g aluminum chloride, 0.1 g lanthanum chloride, and 1.8 g sodium iron phosphate solid powders were added to a high-energy ball milling jar of 500 mL, where a mass ratio of aluminum chloride to lanthanum chloride to sodium iron phosphate was 1:1:18.

### Example 15

This example provided a cathode material containing a halogen-oxygen compound. A specific method for preparing was as follows:

Step 1: 0.4 g aluminum chloride, 0.8 g lithium cobaltate (LiCoO₂), and 0.8 g lithium manganate (LiMnO₂) were added to a high-energy ball milling jar of 500 mL, where a mass ratio of aluminum chloride to lithium cobaltate to lithium manganate was 1:2:2.

Step 2: upon every 10 min of ball milling, ball milling was suspended for 5 min and then continued; and then the above steps were repeated, where a total ball milling duration was controlled as 0.5 h, and a ball milling speed was maintained at 500 rpm.

Except for the ball milling process, loading and unloading processes were carried out in a vacuum glove box, and contents of oxygen and water were both controlled to be less than 0.1 ppm.

### Comparative Example 3

This comparative example differed from Example 15 only in that: 1.2 g aluminum chloride, 0.4 g lithium cobaltate (LiCoO₂), and 0.4 g lithium manganate (LiMnO₂) were added to a high-energy ball milling jar of 500 mL, where a mass ratio of aluminum chloride to lithium cobaltate to lithium manganate was 3:1:1.

### Comparative Example 4

This comparative example differed from Example 15 only in that: 0.04 g aluminum chloride, 0.98 g lithium cobaltate (LiCoO₂), and 0.98 g lithium manganate (LiMnO₂) were added to a high-energy ball milling jar of 500 mL, where a mass ratio of aluminum chloride to lithium cobaltate to lithium manganate was 2:49:49.

### Comparative Example 5

This comparative example differed from Example 15 only in that: a total ball milling duration was controlled as 1 min.

### Comparative Example 6

This comparative example differed from Example 15 only in that: a total ball milling duration was controlled as 24 h.

### Comparative Example 7

This comparative example differed from Example 15 only in that: a ball milling speed was maintained at 50 rpm.

### Comparative Example 8

This comparative example differed from Example 15 only in that: a ball milling speed was maintained at 800 rpm.

### Example 16

This example differed from Example 15 only in that: 0.4 g aluminum chloride, 0.53 g lithium cobaltate (LiCoO₂), 0.53 g lithium manganate (LiMnO₂), and 0.53 g lithium iron phosphate (LiFePO₄) were added to a high-energy ball milling jar of 500 mL, where a mass ratio of aluminum chloride to lithium cobaltate to lithium manganate to lithium iron phosphate was 3:4:4:4.

### Example 17

This example differed from Example 15 only in that: 0.4 g tantalum chloride, 0.53 g lithium cobaltate (LiCoO₂), 0.53 g lithium manganate (LiMnO₂), and 0.53 g lithium iron phosphate (LiFePO₄) were added to a high-energy ball milling jar of 500 mL, where a mass ratio of tantalum chloride to lithium cobaltate to lithium manganate to lithium iron phosphate was 3:4:4:4.

### Example 18

This example differed from Example 15 only in that: 0.4 g aluminum chloride, 0.53 g lithium cobaltate (LiCoO₂), 0.53 g lithium ferromanganese phosphate (LiFe_{0.6}Mn_{0.4}PO₄), and 0.53 g lithium iron phosphate (LiFePO₄) were added to a high-energy ball milling jar of 500 mL, where a mass ratio of aluminum chloride to lithium cobaltate to lithium ferromanganese phosphate to lithium iron phosphate was 3:4:4:4.

### Example 19

This example differed from Example 15 only in that: 0.4 g aluminum chloride, 0.53 g lithium cobaltate (LiCoO₂), 0.53 g lithium ferromanganese phosphate (LiFe_{0.6}Mn_{0.4}PO₄), and 0.53 g lithium iron phosphate (LiFePO₄) were added to a high-energy ball milling jar of 500 mL, where a mass ratio of aluminum chloride to lithium cobaltate to lithium ferromanganese phosphate to lithium iron phosphate was 3:4:4:4, and a total ball milling duration was controlled as 2 h.

### Example 20

This example differed from Example 15 only in that: 0.4 g aluminum chloride, 0.53 g lithium cobaltate (LiCoO₂), 0.53 g lithium ferromanganese phosphate (LiFe_{0.6}Mn_{0.4}PO₄), and 0.53 g lithium iron phosphate LiFePO₄ were added to a high-energy ball milling jar of 500 mL, where a mass ratio of aluminum chloride to lithium cobaltate to lithium ferromanganese phosphate to lithium iron phosphate was 3:4:4:4, a total ball milling duration was controlled as 2 h, and a ball milling speed was maintained at 600 rpm.

### Example 21

This example differed from Example 15 only in that: 0.2 g aluminum chloride, 0.2 g lanthanum chloride, 0.8 g lithium cobaltate (LiCoO₂), and 0.8 g lithium manganate (LiMnO₂) were added to a high-energy ball milling jar of 500 mL, where a mass ratio of aluminum chloride to lanthanum chloride to lithium cobaltate to lithium manganate was 1:1:4:4.

### Example 22

This example differed from Example 15 only in that: 0.2 g aluminum chloride, 0.2 g zirconium chloride, 0.8 g lithium cobaltate (LiCoO₂), and 0.8 g lithium manganate (LiMnO₂) were added to a high-energy ball milling jar of 500 mL, where a mass ratio of aluminum chloride to zirconium chloride to lithium cobaltate to lithium manganate was 1:1:4:4.

### Example 23

This example differed from Example 15 only in that: 0.2 g aluminum chloride, 0.2 g zirconium chloride, 0.8 g lithium cobaltate (LiCoO₂), and 0.8 g lithium iron phosphate (LiFePO₄) were added to a high-energy ball milling jar of 500 mL, where a mass ratio of aluminum chloride to zirconium chloride to lithium cobaltate to lithium iron phosphate was 1:1:4:4.

### Example 24

This example differed from Example 15 only in that: 0.2 g aluminum chloride, 0.2 g lanthanum chloride, 0.8 g lithium cobaltate (LiCoO₂), and 0.8 g lithium manganate (LiMnO₂) were added to a high-energy ball milling jar of 500 mL, where a mass ratio of aluminum chloride to lanthanum chloride to lithium cobaltate to lithium manganate was 1:1:4:4, and a total ball milling duration was controlled as 4 h.

### Example 25

This example differed from Example 15 only in that: 0.2 g aluminum chloride, 0.2 g lanthanum chloride, 0.8 g lithium cobaltate (LiCoO₂), and 0.8 g lithium manganate (LiMnO₂) were added to a high-energy ball milling jar of 500 mL, where a mass ratio of aluminum chloride to lanthanum chloride to lithium cobaltate to lithium manganate was 1:1:4:4, and a ball milling speed was maintained at 600 rpm.

### Example 26

This example differed from Example 15 only in that: 0.2 g aluminum chloride, 0.2 g lanthanum chloride, 0.53 g lithium cobaltate (LiCoO₂), and 0.53 g lithium manganate were added to a high-energy ball milling jar of 500 mL, where a mass ratio of aluminum chloride to lanthanum chloride to lithium cobaltate to lithium manganate was 3:3:8:8.

### Example 27

This example differed from Example 15 only in that: 0.2 g aluminum chloride, 0.2 g zirconium chloride, 0.53 g lithium cobaltate (LiCoO₂), and 0.53 g lithium manganate were added to a high-energy ball milling jar of 500 mL, where a mass ratio of aluminum chloride to zirconium chloride to lithium cobaltate to lithium manganate was 3:3:8:8.

### Example 28

This example differed from Example 15 only in that: 0.2 g aluminum chloride, 0.2 g lanthanum chloride, 0.53 g lithium cobaltate (LiCoO₂), 0.53 g lithium manganate (LiMnO₂), and 0.53 g lithium iron phosphate were added to a high-energy ball milling jar of 500 mL, where a mass ratio of aluminum chloride to lanthanum chloride to lithium cobaltate to lithium manganate to lithium iron phosphate was 3:3:8:8:8.

### Example 29

This example differed from Example 15 only in that: 0.2 g aluminum chloride, 0.2 g lanthanum chloride, 0.53 g lithium cobaltate (LiCoO₂), 0.53 g lithium manganate, and 0.53 g lithium ferromanganese phosphate (LiFe_{0.6}Mn_{0.4}PO₄) were added to a high-energy ball milling jar of 500 mL, where a mass ratio of aluminum chloride to lanthanum chloride to lithium cobaltate to lithium manganate to lithium ferromanganese phosphate was 3:3:8:8:8, and a total ball milling duration was controlled as 2 h.

### Example 30

This example differed from Example 15 only in that: 0.2 g aluminum chloride, 0.2 g lanthanum chloride, 0.53 g lithium cobaltate (LiCoO₂), 0.53 g lithium manganate (LiMnO₂), and 0.53 g lithium ferromanganese phosphate (LiFe_{0.6}Mn_{0.4}PO₄) were added to a high-energy ball milling jar of 500 mL, where a mass ratio of aluminum chloride to lanthanum chloride to lithium cobaltate to lithium manganate to lithium ferromanganese phosphate was 3:3:8:8:8, and a ball milling speed was maintained at 600 rpm.

### I. Structural Characterization

### 1. Electron Microscopy Analysis:

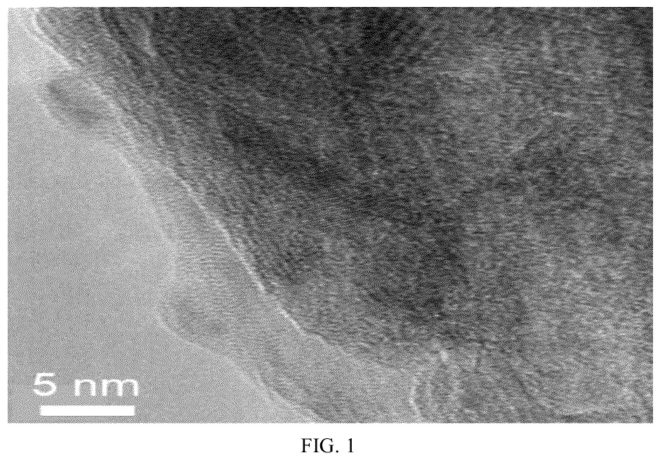

FIG. 1 is a TEM lattice diagram of a cathode material containing a halogen-oxygen compound provided in Example 1. As can be seen from the TEM image of FIG. 1, a material obtained from ball milling of lithium cobaltate and aluminum chloride has obvious amorphous regions. In addition, regions with obvious lattices in the figure are residual lithium cobaltate. This indicates that in a case where one type of crystalline phase cathode material is used for ball milling with a halide, the structure of the obtained material is a core-shell structure, where a core is the crystalline phase cathode material, and a shell is an amorphous halogen-oxygen compound.

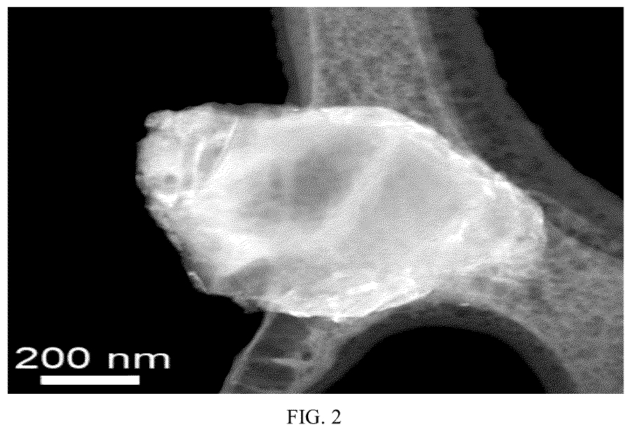

FIG. 2 is a TEM morphology diagram of the cathode material containing the halogen-oxygen compound prepared in Example 1. It can be observed that the structures of lithium cobaltate and aluminum chloride still remain intact after ball milling, without obvious damage.

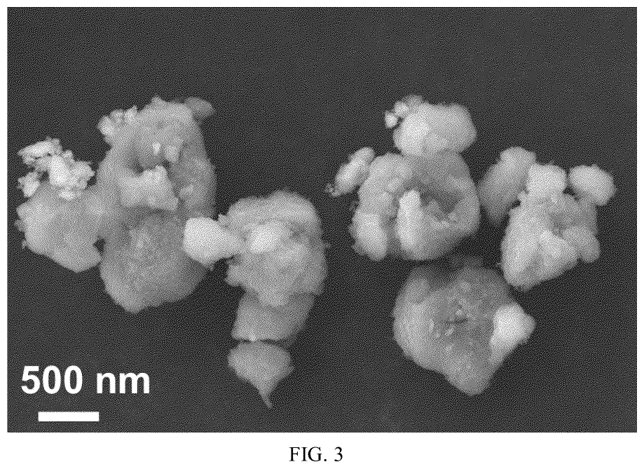

FIG. 3 is an SEM diagram of the cathode material prepared in Comparative Example 1. It can be observed that when the mass ratio of aluminum chloride is too high, most of particles formed are halides, and no obvious crystalline phase cathode material particles appear, indicating that the cathode material containing the halogen-oxygen compound has not been successfully prepared.

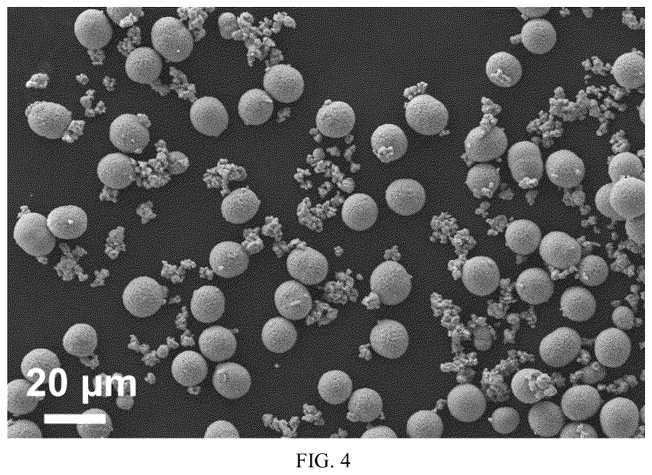

FIG. 4 is an SEM diagram of the cathode material prepared in Comparative Example 2. It can be observed that when the mass ratio of lithium cobaltate is too high, most of particles are in the morphology of lithium cobaltate itself, and only a small number of crystalline phase cathode material particles dissociate with aluminum chloride, so that an ideal product cannot be obtained.

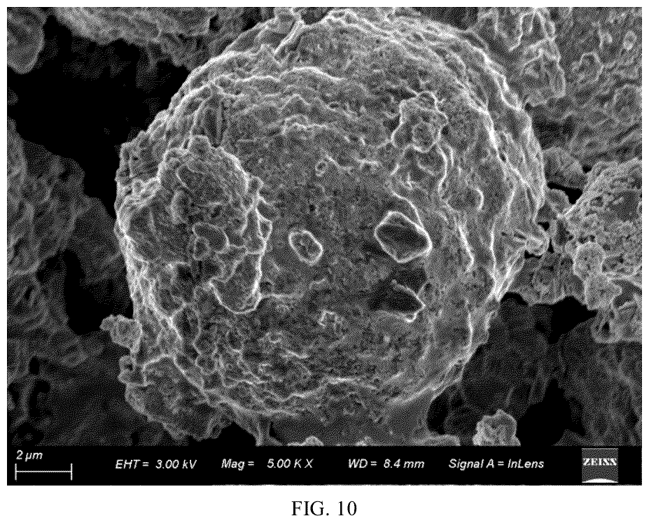

The cathode material prepared in Example 15 is photographed by scanning electron microscopy to obtain the morphology. At the same time, the effects of different ball milling speeds and ball milling times on the morphology of the cathode material are compared. The results are shown in FIG. 10 to FIG. 14.

As shown in FIG. 10, in Example 15, by controlling the ball milling speed and the ball milling time to be appropriate, a solid solution type cathode material with regular spherical particles is prepared, with no obvious amorphous region produced and the morphology and structure remaining relatively intact.

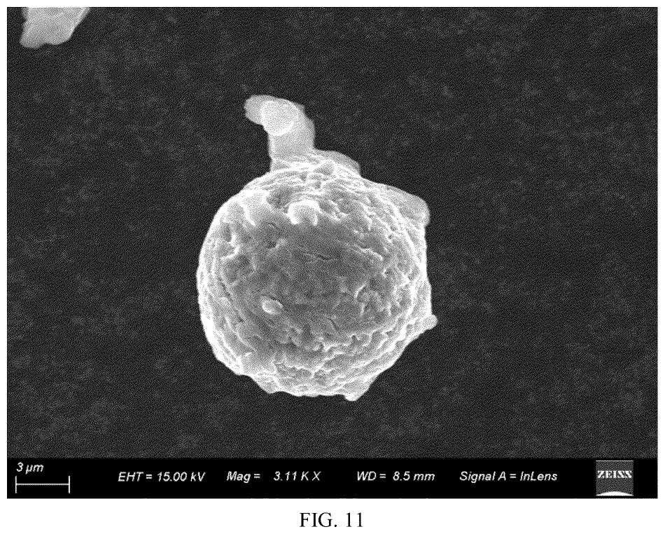

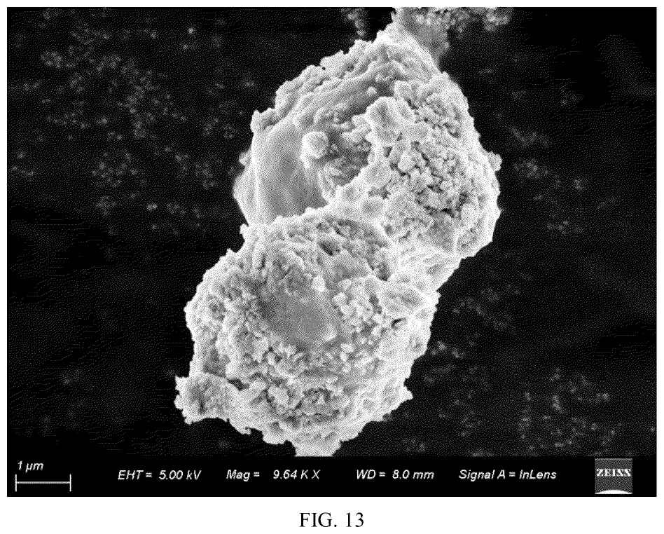

As shown in FIG. 11 and FIG. 13, in Comparative Examples 5 and 7, it is found that when the ball milling time is too short or the ball milling speed is too low, the morphology of a sample is relatively close to that of initial cathode material particles, and no obvious solid solution reaction occurs with the halide.

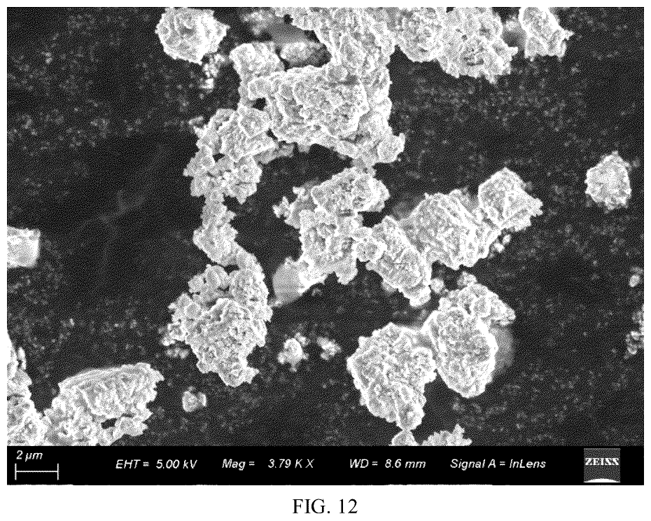

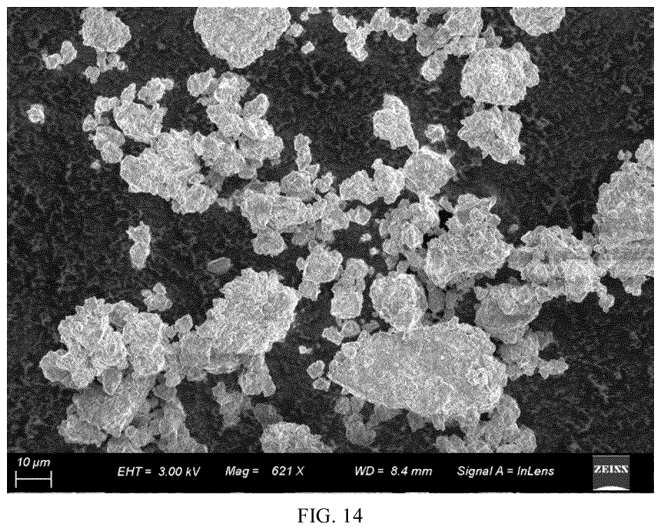

As shown in FIG. 12 and FIG. 14, in Comparative Examples 6 and 8, it is found that when the ball milling time is too long or the ball milling speed is too high, the morphology of the sample is severely damaged and is particles of varying sizes and shapes.

### 2. X-Ray Diffraction Analysis:

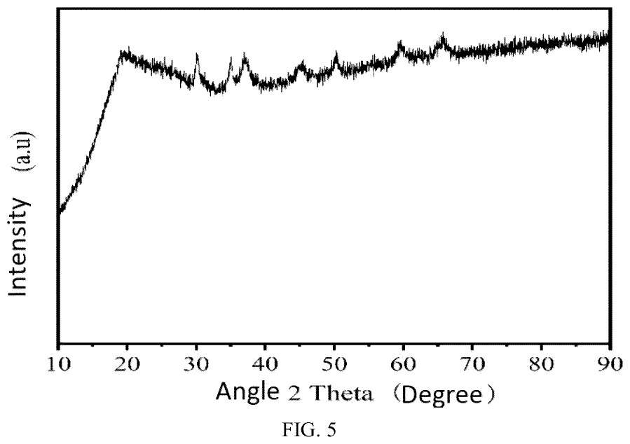

FIG. 5 is an XRD diagram of the cathode material containing the halogen-oxygen compound prepared in Example 1. It can be clearly seen from FIG. 5 that a sharp peak of lithium cobaltate at about 200 disappears and is changed into a diffraction broad peak, which further proves that an amorphous phase structure is produced by the material obtained after ball milling of one type of crystalline phase cathode material and the halide.

### II. Performance Test

### 1. Preparation of Battery:

The battery was assembled in a glove box full of argon by using the prepared cathode material containing the halogen-oxygen compound and a LiIn anode. First, about 120 mg Li₆PS₅Cl powder was pressed at 100 MPa for 1 min (with a diameter of 10 mm) to obtain a solid electrolyte. A composite cathode mixture was prepared by mixing the cathode material, Li₆PS₅Cl and carbon black in a weight ratio of 70:30:1. About 10 mg of the composite cathode mixture was spread on one side of the solid electrolyte Li₆PS₅Cl, and pressed at 300 MPa for 2 minutes. A thin indium foil (with a diameter of 10 mm) was attached to the other side of the solid electrolyte, and a lithium foil of about 2 mg was pressed into a thin layer and placed on the indium foil to obtain a composite cathode. Mass loading of the cathode materials for the composite cathodes corresponding to Example 1, Comparative Example 1 and Comparative Example 2 was 8 mg cm⁻². Mass loading of the cathode materials for the composite cathodes corresponding to Example 15, Comparative Example 3 and Comparative Example 4 was 6 mg cm².

### 2. Test Methods:

Constant-current charge/discharge voltages were set to be 2.5 V-4.3 V with respect to Li⁺/Li. A charge and discharge curve test was carried out at a current density of 0.1 c. Cycling performance tests were carried out on batteries corresponding to Example 1, Comparative Example 1 and Comparative Example 2 at a current density of 0.5 A g⁻¹. Cycling performance tests were carried out on batteries corresponding to Example 15, Comparative Example 3 and Comparative Example 4 at a current density of 0.3 A g⁻¹.

### 3. Test Results:

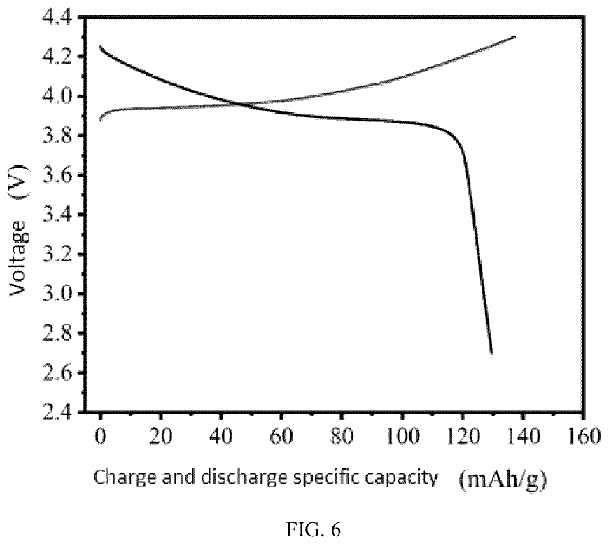

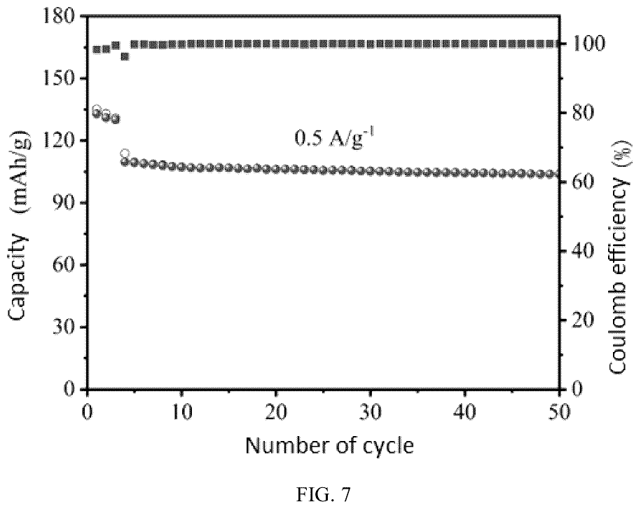

As shown in FIG. 6 and FIG. 7, the capacity of the cathode material provided in Example 1 still stably remains at 110 mAh g⁻¹ after 50 cycles at 0.5 c. For a first cycle at a current density of 0.1 c, the discharge capacity may be up to 130 mAh g⁻¹, and the Coulomb efficiency of the first cycle is 94.8%.

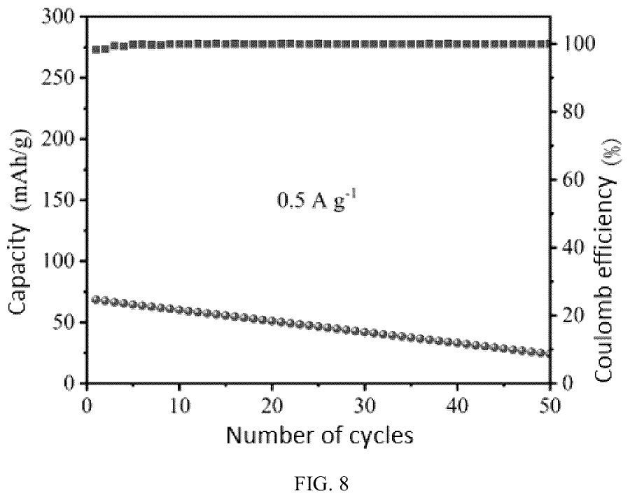

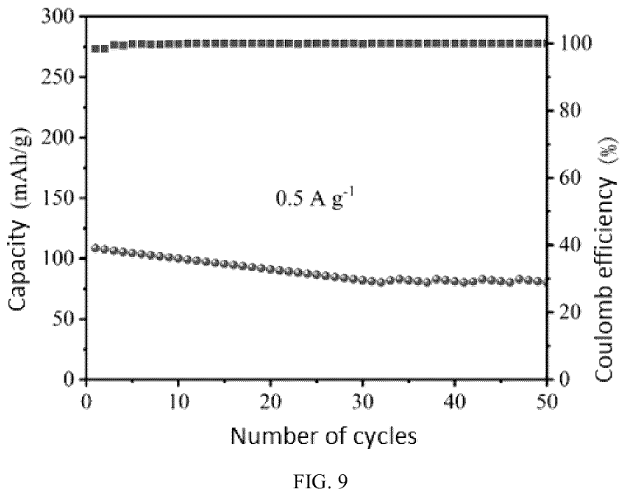

As shown in FIG. 8 and FIG. 9, the cathode materials provided by Comparative Examples 1 and 2 show completely different electrochemical performances after 50 cycles at 0.5 c. For the cathode prepared in Comparative Example 1, the capacity is only 70 mAh g⁻¹ in the first cycle, and then is continuously attenuated to 25 mAh g⁻¹ for the next 50 cycles. This is due to the excessively high mass ratio of halides, resulting in the majority of the obtained cathode material being halides, which reduces the battery capacity. The cycling performance of the cathode prepared in Comparative Example 2 is more stable compared to that of Comparative Example 1, but the capacity is still seriously attenuated compared to Example 1. After 50 cycles, the capacity is only 75 mAh g⁻¹. This is due to the excessively low mass ratio of halides, resulting in the content of the halogen-oxygen compound in the obtained cathode material being too low, which has very limited improvement on battery performance.

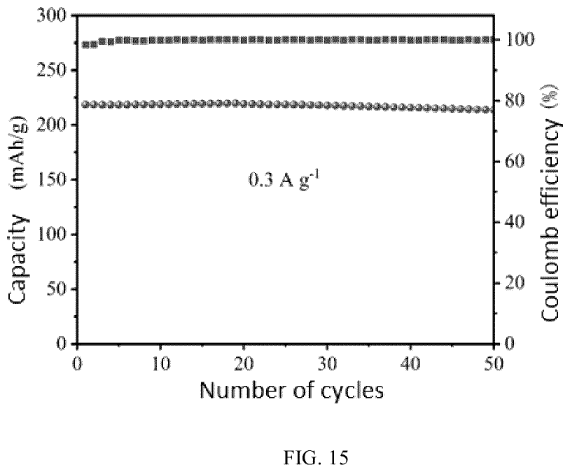

As shown in FIG. 15, the solid solution type cathode material synthesized in Example 15 by controlling the mass ratio of the halide to the crystalline phase cathode material to be appropriate shows excellent cycling performance and high reversible capacity, and the capacity still remains at 218 mAh g⁻¹ after 50 cycles at 0.3 C.

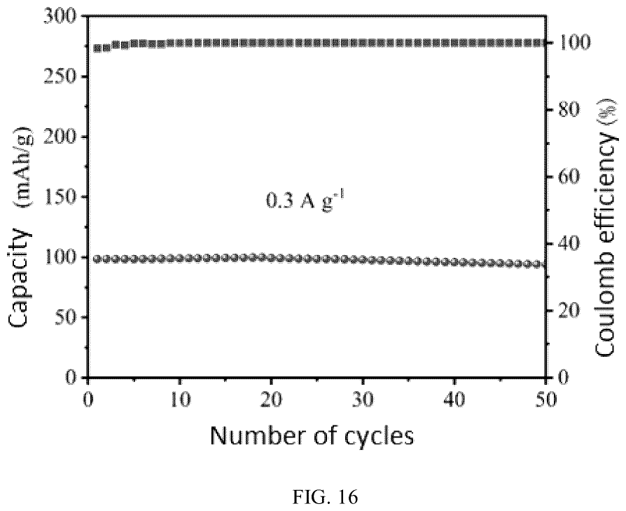

As shown in FIG. 16, in Comparative Example 3, as the mass ratio of halides is too high, the battery capacity is attenuated, and the capacity is attenuated to 100.5 mAh g⁻¹.

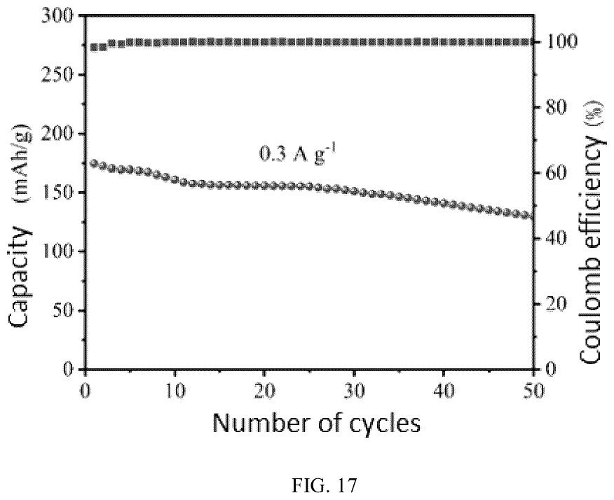

As shown in FIG. 17, in Comparative Example 4, as the mass ratio of halides is too low, the performance of an all-solid-state battery deteriorates dramatically, with severe capacity attenuation and decreased cycle stability. After 50 cycles, the capacity is only 124.9 mAh g⁻¹.

The specific embodiments described above further describe the object, technical solutions and beneficial effects of the present disclosure in detail. It should be understood that the above descriptions are merely specific embodiments of the present disclosure, and are not used to limit the scope of protection of the present disclosure, and any modification, equivalent replacement, improvement, etc. made within the spirit and principle of the present disclosure shall fall within the scope of protection of the present disclosure.

What is claimed is:

1. A method for preparing a cathode material containing a halogen-oxygen compound, comprising:
ball milling at least one crystalline phase cathode material and at least one halide MX_{y} to obtain the cathode material containing the halogen-oxygen compound, wherein
in the halide MX_{y}, M comprises at least one of metallic elements or semi-metallic elements other than radioactive metallic elements, X comprises at least one of F, Cl, Br or I, and y is an integer between 1 and 6;
in a case where one type of crystalline phase cathode material is provided, the crystalline phase cathode material is a lithium-ion battery cathode material or a sodium-ion battery cathode material; in a case where two or more types of crystalline phase cathode materials are provided, the crystalline phase cathode materials are lithium-ion battery cathode materials; and the lithium-ion battery cathode material and the sodium-ion battery cathode material are both oxygen-containing materials.

2. The method for preparing the cathode material containing the halogen-oxygen compound according to claim 1, wherein the lithium-ion battery cathode material comprises at least one of a layered-type material, a spinel-type material or an olivine-type material.

3. The method for preparing the cathode material containing the halogen-oxygen compound according to claim 2, wherein the layered-type material comprises at least one of LiₓCoO₂, LiₓNiO₂, LiₓMnO₂, LiₓNi_{1-y}Mn_{y}O₂, LiₓNi_{1-y}Co_{y}O₂, LiₓNi_{z}CoyMn_{1-x-y}O₂, LiₓCo_{1-y}Mn_{y}O₂ or Li₂MnO₃, where 0.5<x<1.10; in LiₓNi_{1-y}Mn_{y}O₂, 0.1≤y≤0.5; in LiₓNi_{1-y}Co_{y}O₂, 0.1≤y≤0.5; in LiₓNi_{z}Co_{y}Mn_{1-x-y}O₂, 0.1≤z≤0.8, 0.1≤y≤0.8, and 0.2≤z+y≤0.9; and in LiₓCo_{1-y}Mn_{y}O₂, 0.1≤y≤0.5;
and/or, the spinel-type material comprises at least one of LiMn₂O₄ or LiNi_{0.5}Mn_{1.5}O₄;
and/or, the olivine-type material is LiNPO₄, where N is selected from at least one of Fe, Co, Mn or Ni.

4. The method for preparing the cathode material containing the halogen-oxygen compound according to claim 1, wherein the sodium-ion battery cathode material comprises at least one of a transition metal oxide material, a poly-anionic compound material or a Prussian blue compound material.

5. The method for preparing the cathode material containing the halogen-oxygen compound according to claim 4, wherein the poly-anionic compound material comprises at least one of sodium vanadium phosphate or sodium iron phosphate.

6. The method for preparing the cathode material containing the halogen-oxygen compound according to claim 1, wherein the halide comprises at least one of aluminum fluoride, aluminum chloride, aluminum bromide, aluminum iodide, lanthanum fluoride, lanthanum chloride, lanthanum bromide, lanthanum iodide, tantalum fluoride, tantalum chloride, tantalum bromide, tantalum iodide, hafnium fluoride, hafnium chloride, hafnium bromide, hafnium iodide, zirconium fluoride, zirconium chloride, zirconium bromide or zirconium iodide.

7. The method for preparing the cathode material containing the halogen-oxygen compound according to claim 1, wherein one type of halide is provided, one type of crystalline phase cathode material is provided, and a mass ratio of the halide to the crystalline phase cathode material is 1:1 to 1:19;
and/or, two types of halides are provided, one type of crystalline phase cathode material is provided, and a mass ratio of the two types of halides to the crystalline phase cathode material is 1:1:18 to 1:1:2;
and/or, one type of halide is provided, two types of crystalline phase cathode materials are provided, and a mass ratio of the halide to the two types of crystalline phase cathode materials is 2:1:1 to 2:19:19;
and/or, one type of halide is provided, three types of crystalline phase cathode materials are provided, and a mass ratio of the halide to the three types of crystalline phase cathode materials is 3:1:1:1 to 1:33:33:33;
and/or, two types of halides are provided, two types of crystalline phase cathode materials are provided, and a mass ratio of the two types of halides to the two types of crystalline phase cathode materials is 1:1:1:1 to 1:1:99:99;
and/or, two types of halides are provided, three types of crystalline phase cathode materials are provided, and a mass ratio of the two types of halides to the three types of crystalline phase cathode materials is 3:3:2:2:2 to 1:1:66:66:66.

8. The method for preparing the cathode material containing the halogen-oxygen compound according to claim 1, wherein one type of crystalline phase cathode material is provided, a ball milling speed is 100 rpm to 700 rpm, and a ball milling duration is 0.1 h to 48 h;
or, at least two types of crystalline phase cathode materials are comprised, the ball milling speed is 100 rpm to 700 rpm, and the ball milling duration is 0.1 h to 22 h.

9. A cathode material containing a halogen-oxygen compound obtained by using the method for preparing according to claim 1.

10. The cathode material containing the halogen-oxygen compound according to claim 9, wherein a lithium-ion battery cathode material comprises at least one of a layered-type material, a spinel-type material or an olivine-type material.

11. The cathode material containing the halogen-oxygen compound according to claim 10, wherein the layered-type material comprises at least one of LiₓCoO₂, LiₓNiO₂, LiₓMnO₂, LiₓNi_{1-y}Mn_{y}O₂, LiₓNi_{1-y}Co_{y}O₂, LiₓNi_{z}Co_{y}Mn_{1-x-y}O₂, LiₓCo_{1-y}Mn_{y}O₂ or Li₂MnO₃, where 0.5<x<1.10; in LiₓNi_{1-y}Mn_{y}O₂, 0.1≤y≤0.5; in LiₓNi_{1-y}Co_{y}O₂, 0.1≤y≤0.5; in LiₓNi_{z}Co_{y}Mn_{1-x-y}O₂, 0.1≤z≤0.8, 0.1≤y≤0.8, and 0.2≤z+y≤0.9; and in LiₓCo_{1-y}Mn_{y}O₂, 0.1≤y≤0.5;
and/or, the spinel-type material comprises at least one of LiMn₂O₄ or LiNi_{0.5}Mn_{1.5}O₄;
and/or, the olivine-type material is LiNPO₄, where N is selected from at least one of Fe, Co, Mn or Ni.

12. The cathode material containing the halogen-oxygen compound according to claim 9, wherein a sodium-ion battery cathode material comprises at least one of a transition metal oxide material, a poly-anionic compound material or a Prussian blue compound material.

13. The cathode material containing the halogen-oxygen compound according to claim 12, wherein the poly-anionic compound material comprises at least one of sodium vanadium phosphate or sodium iron phosphate.

14. The cathode material containing the halogen-oxygen compound according to claim 9, wherein a halide comprises at least one of aluminum fluoride, aluminum chloride, aluminum bromide, aluminum iodide, lanthanum fluoride, lanthanum chloride, lanthanum bromide, lanthanum iodide, tantalum fluoride, tantalum chloride, tantalum bromide, tantalum iodide, hafnium fluoride, hafnium chloride, hafnium bromide, hafnium iodide, zirconium fluoride, zirconium chloride, zirconium bromide or zirconium iodide.

15. A cathode plate, comprising the cathode material containing the halogen-oxygen compound according to claim 9.

16. The cathode plate according to claim 15, wherein a lithium-ion battery cathode material comprises at least one of a layered-type material, a spinel-type material or an olivine-type material.

17. The cathode plate according to claim 16, wherein the layered-type material comprises at least one of LiₓCoO₂, LiₓNiO₂, LiₓMnO₂, LiₓNi_{1-y}Mn_{y}O₂, LiₓNi_{1-y}Co_{y}O₂, LiₓNi_{z}Co_{y}Mn_{1-x-y}O₂, LiₓCo_{1-y}Mn_{y}O₂ or Li₂MnO₃, where 0.5<x<1.10; in LiₓNi_{1-y}Mn_{y}O₂, 0.1≤y≤0.5; in LiₓNi_{1-y}Co_{y}O₂, 0.1≤y≤0.5; in LiₓNi_{z}Co_{y}Mn_{1-x-y}O₂, 0.1≤z≤0.8, 0.1≤y≤0.8, and 0.2≤z+y≤0.9; and in LiₓCo_{1-y}Mn_{y}O₂, 0.1≤y≤0.5;
and/or, the spinel-type material comprises at least one of LiMn₂O₄ or LiNi_{0.5}Mn_{1.5}O₄;
and/or, the olivine-type material is LiNPO₄, where N is selected from at least one of Fe, Co, Mn or Ni.

18. The cathode plate according to claim 15, wherein a sodium-ion battery cathode material comprises at least one of a transition metal oxide material, a poly-anionic compound material or a Prussian blue compound material.

19. The cathode plate according to claim 18, wherein the poly-anionic compound material comprises at least one of sodium vanadium phosphate or sodium iron phosphate.

20. The cathode plate according to claim 15, wherein a halide comprises at least one of aluminum fluoride, aluminum chloride, aluminum bromide, aluminum iodide, lanthanum fluoride, lanthanum chloride, lanthanum bromide, lanthanum iodide, tantalum fluoride, tantalum chloride, tantalum bromide, tantalum iodide, hafnium fluoride, hafnium chloride, hafnium bromide, hafnium iodide, zirconium fluoride, zirconium chloride, zirconium bromide or zirconium iodide.
